(19) United States
(12) Patent Application Publication
(10) Pub. No.: US 2021/0030036 A1
(43) Pub. Date: Feb. 4, 2021

(54) Hybrid Snacks and Treats

(71) Applicant: Liliya Varon-Weinryb, Waltham, MA (US)

(72) Inventor: Liliya Varon-Weinryb, Waltham, MA (US)

(21) Appl. No.: 16/926,742

(22) Filed: Jul. 12, 2020

Related U.S. Application Data
(60) Provisional application No. 62/880,869, filed on Jul. 31, 2019.

(51) Int. Cl. A23L 25/10; A23K 50/40; A23K 10/20; A23K 20/174; A23L 13/50; A23K 10/30

(52) U.S. Cl. CPC A23L 25/10; A23K 50/40; A23K 10/30; A23K 20/174; A23L 13/52; A23K 10/20

(57) ABSTRACT

The present invention relates to a food product for consumption by both people and pets, comprising: (a) manufacturing practices which support both a human and a pet consumption; (b) ingredients which support consumption by both a person and a pet; (c) nutrition values which support consumption by both a person and a pet; (e) a recipe which is appealing for both a person and a pet.

### FIELD OF THE INVENTION

The field of the invention relates to food products which are designed, optimized, manufactured and marketed as food to be suitable for consumption both by people and by their pets. More particularly, the invention relates to snacks and treats which are intended to be consumed by both people and pets, as their ingredients and their nutrition values will be optimized for both peoples' and pets' consumption, and their recipes will be tasty and appealing for both a person and a pet. From a GMP perspective, the food according to the invention will follow strict GMP guidelines for both human and pet consumption, therefore will be good for people as well as for pets.

### BACKGROUND OF THE INVENTION

The food industry for people and the food industry for pets are two separate industries having separate production lines. A dog's food is intended to be solely consumed by dogs. It may be the main food which includes all ingredients a dog needs, or a dog's supplementary food for the purpose of additional vitamins and mineral support, or for the purpose of a snack or a treat—for all said cases, the related industrial and commercial products may be consumed by dogs only. The same applies for cats' food. Obviously, people cannot and must not consume a dog's food or a cat's food, as these foods are not intended to be consumed by human beings. The ingredients, the nutrition values, the production processes, the safety regulations and the quality-related regulations are not aimed to support a human consumption.

Vice versa, people food is not a pet food. This does not mean that a person cannot share, occasionally, some of his food with his pet. But, from a pet's health perspective, it might be tricky and requires precaution. While the GMP (Good Manufacturing Practices) guidelines for people's food are at least as good as and even superior to animals food's GMP regulations, the content of a harmless people's food may be harmful and toxic to a feline or to a canine, and in other cases may just not be tasty or appealing to the pet.

One example is a presence of artificial sweeteners which must not be consumed by dogs and cats, and which is a common addition to people food, added not only for sweets.

Yet another example is various types of nuts, which are commonly added to human food, and particularly added to human snacks, but must not be consumed by pets.

Yet another example is grapes, which are toxic for dogs.

It is therefore an object of the present invention to provide off-the-shelf hybrid food products which are intended to be consumed both by pets and by their owners. particularly, it is an object of the present invention to provide snacks which are intended to be consumed by people and by their pets. Such snacks will be based on carefully built and prepared recipes, such that they include only ingredients and nutrition values which are allowed to be consumed by both the person and the pet, and such that they are tasty for the person and tasty for the pet.

It is a particular object of the present invention to provide a snack for people and canines.

It is yet another particular object of the present invention to provide a snack for people and felines.

Other objects and advantages of the present invention will become apparent as the description proceeds.

### SUMMARY OF THE INVENTION

The invention relates to a food product for consumption by both people and pets, comprising: (a) manufacturing practices which support both a human and a pet consumption; (b) ingredients which support consumption by both a person and a pet; (c) nutrition values which support consumption by both a person and a pet and (d) a recipe which is appealing for both a person and a pet; Preferably, said pets are dogs.

Preferably, said pets are cats.

Preferably, said pets are both dogs and cats.

Preferably, said food product is a supplementary food for the pet.

Preferably, said food product is a snack.

Preferably, said food product is a treat.

Preferably, said food product is the main source of nutrition for the pet.

### BRIEF DESCRIPTION OF THE DRAWINGS

In the drawings:

FIG. 1 shows an example for a hybrid person—dog snack's package with suggested printed labeling and data;

FIG. 2 shows an example for a hybrid person—cat snack's package with suggested printed labeling and data;

### DETAILED DESCRIPTION OF PREFERRED EMBODIMENTS

The emotional bonds between people and their pets are ancient and strong. Pets have literally been part of a human family for ages. In some cases, pets even have a formal therapeutic emotional support role. Such role emphasizes the fact that modern science acknowledges the importance psychological and emotional role of pets in people's life. Generally, pets have a significant part in the life of people all over the world. Particularly, pets are significant companions to children and to people who live alone. The number of single-person households is on a rise. Currently, 28 percent of households in the US are single-person households, where a person-pet emotional bond is even more critical, typically, comparing to non-single-person households.

In the US, 68 percent of the households include a pet. Assuming an equal distribution between single-person households and non-single-person households, nearly 20 percent of US households are single-person households which own a cat or a dog.

As stated, pets have a significant part in the life and in the well-being of people, and particularly in the life of said 20 percent single-person households.

As ancient as a person-pet emotional connection, and even more ancient, is the emotional gesture of sharing a meal with each other. Sharing a food with the other is, and has always been, a powerful bonding act. It is therefore the purpose of this invention to allow a person to share his food with his pet. Not just eating together, but literally sharing the very same food, originated from the very same package. Such act will be a powerful emotional joint activity of a person and such person's pet, which will enhance the bond, the partnership and the mutual feelings of these two living-creatures—a person and a pet.

Even from the technical aspect of operations, the current invention makes sense and leads to a natural, easy and uniting routine. Currently the pet owner may open the dog's food package, provide the snack to the dog, then wash hands from the non-suitable-for-human-consumption food, and open a package of people's snack. And these operations are currently the best-case scenario. In many cases a person just does not bother to do so, and simply feeds the pet separately. But according to the current investment, a person may wash hands, open the hybrid snack package, provide some of its content to the pet, and eat the reminder of the snack from the very same package. Hybrid snack, in the context of this invention, means a food product which is intended to be consumed both by a person and by a pet. The person may also add, from time to time, some of the snacks to the pet's plate, while continue eating the snacks. This is a true act of sharing food and a powerful experience for the person, and probably also for the pet. It's two family members sharing the same food and enjoying eating it together.

While it is possible for a cat owner or a dog owner to prepare their pets food at home, it is difficult, and most pets' owners do not do it. Not only it takes time, but it also requires understanding of what is right and what is wrong for a pet's diet, what is allowed and what is not allowed, and also what is tasty and what is not, from the pet's perspective. Just as an example: onions, which is harmless and even healthy for people—are dangerous and toxic for pets.

If such food needs to be also eatable and tasty for the pet's owner, the task is even more complicated, with many variables, person related and pet related, that need to be considered.

According to this invention, an off-the-shelf hybrid food product of a person-pet snack will be manufactured and marketed.

Though it is possible to create a snack according to the invention, which is suitable for people, for dogs and for cats, all together, the best embodiments are separate person-dog snacks and person-cat snacks for the following reasons:
(a) The recommended diet for dogs and the recommended diet for cats are different. Dogs' diet is more flexible with more options, while cats' diet is somewhat more complicated, and need to include more proteins. Constraints and limitations are different for felines and for canines.
(b) A separation between a cat's snack and a dog's snack may enable developing snacks which are typically more appealing for each.
(c) Separating the person-dog brand from the person-cat brand makes more sense from the emotional influence of the brand on the human consumer.

Developing such hybrid food, according to the invention, which can also function as the main or the only diet of the pet, would be complicated, though it is possible. However, such constraints of providing anything the pet needs within the hybrid product are not a must and they complicate the task. The most reasonable implementation of the invention will be a snack which is not the main source of food for the pet but is a complementary meal. Such approach enables more flexibility relating to the ingredients, their proportions and the related nutrition values, and it will enable developing snacks which are better appealing to both the person and the pet.

While the ingredients are, by definition, the same ingredients, still the amount per serving for such a hybrid snack is likely to be different for the person and for the pet. Unless the person consumes a very small serving, the pet's serving will be typically much smaller than the person's serving. A daily caloric need for a 10 lbs cat is around 200 calories. A daily caloric need for a 10 lbs dog is around 250 calories. People's daily calories needs are around 2000 for females and 2500 for males. Therefore, if the typical hybrid-snack's serving for a person is around 100 calories, which is 4 to 5 percent of the daily caloric need, the typical serving for a pet might be around 10 to 20 calories for a 10 lbs. pet.

The proportion between calories per serving and a daily caloric need do not need to be identical for a person and for a pet. For example, while a serving of 5% of the daily caloric need might be recommended for a typical serving for a person, the recommendation for the serving size of the same hybrid snack for the pet might be 10% percent of the pet's daily caloric need.

Moreover, even as a complementary food, the hybrid snack may have a different nutrition role for the person and for the pet. For example, suppose that the amount of a specific vitamin in a person's serving is 0.5 mg, which is 15% of the recommended daily consumption for such vitamin. If the pet's recommended serving size is 5 times smaller than the person's serving size, than the amount of said vitamin in the pet's portion is 0.1 mg. However, it may be the case that, for the pet, this is a more significant portion of such vitamin, as it stands for 40% of the recommended daily consumption of such vitamin for the pet. Based on the snack's composition, it might boost some elements, such as proteins or a specific vitamin, for the pet, while the person's serving does not provide a significant boost of such elements, as the related percentage of a daily consumption is insignificant for the person. In any case, the scope of ingredients and the proportions of Main Food Groups will always be within the recommended ranges for both the person and the pet. Based on the ingredients and the preparation methods, the snack might even be categorized specifically as a healthy snack. For example: a baked all-natural low-fat snack with no preservations.

It should be noted that if the percentage of the recommended daily consumption of a specific item is indicated for a person, it does not necessarily need to be provided for the pet, and vise versa. For example, assuming a hybrid snack for a person and a cat: if the nutrition facts' table indicates the amount of proteins in grams for the person's serving and for the cat's serving, it may also indicate the percentage of recommended daily consumption value for a cat, but not necessarily indicate the related percentage of recommended daily consumption for the person. On the other hand, if such snack indicates the amount of Folic Acid in mcg for the person's serving and for the cat's serving, it may also indicate the related percentage of recommended daily consumption value of said Folic Acid for the person, but not necessarily indicate the related percentage for the cat. Therefore, the nutrition facts table will not necessarily include the same items at the same level of details for people and for pets.

The information provided on the hybrid snack's package must be compatible with the regulations referring to both pets and people. The regulations for people are, obviously, more severe. The ingredients list and the nutrition facts must follow such regulations. A good practice will be to align the pet's labeling and data sheets with the person's data. This may typically include:
(a) Serving size for the person and serving size for the pet.
(b) Calories per serving for the person and for the pet.
(c) A table with a list of nutrition values per serving, with the following columns: (c1) amount for a person, (c2) percentage of recommended daily value for a person, (c3) amount for the pet, (c4) percentage of recommended daily value for the pet.

Since the weight of dogs may typically vary from 10 lbs for a small dog to 90 lbs for a big dog, such factor must be considered. One convenient way to address this will be to assign all nutrition values for a 10 lbs dog, and to provide a simple formula on the package, allowing the conversion of the serving size and related nutrition facts to bigger dogs. A reasonable and recommended example for such formula might be:

[Serving Size]=7+1.35×[Dog Weight] (a)

where:
[Serving Size] is the recommended serving size in calories; and
[Dog Weight] is the weight of the dog in lbs.

The Serving Size calculation based on this suggested formula will lead to approximately 10% of the Daily Caloric Need of the dog, regardless of the dog's size.

If the weight in oz of the serving size for a 10 lbs dog is printed on the package, then a serving size for a bigger dog can be calculated by multiplying the printed serving size by a Serving Size Factor, which can be calculated relating to the 10 lbs dog's portion as:

[Serving Size Factor]=[Serving Weight (Actual)]/[Serving Weight (10)] (b)

Where:
[Serving Size Factor] is the said multiplier; and
[Serving Weight (Actual)] is the weight of the Serving Size based on the dog's actual weight; and
[Serving Weight (10)] is the weight of the Serving Size based on a 10 lbs dog's weight.

The values of the Serving Size according to said formula (a) and the value of the Serving Size Factor according to said formula (b) are summarized in Table 1.

TABLE 1

| Dog Weight [lbs] | Serving Size [calories] | % of Daily Caloric Need | Serving Size Factor |
|---|---|---|---|
| 10 | 21 | 10% | 100% |
| 20 | 34 | 10% | 166% |
| 30 | 48 | 10% | 232% |
| 40 | 61 | 10% | 298% |
| 50 | 75 | 10% | 363% |
| 60 | 88 | 10% | 429% |
| 70 | 102 | 10% | 495% |
| 80 | 115 | 10% | 561% |
| 90 | 129 | 10% | 627% |

For example, the Serving Size Factor for a 40 lbs dog is 298%, so if, for example, the serving size weight for a 10 lbs dog is 1 oz, than the serving size for a 40 lbs dog will be 3 oz.

It should be noted that said calculation is required for canines but not for felines, as dogs weight varies within a very wide range, while the range for cats is limited. A 10 lbs weight is a typical value for adult cats, and in rare cases it may reach a value of 13 to 18 lbs—for example for males of a Main Coon breed, but typically said calculation is not required for cats.

The invention will be farther explained and demonstrated hereby with various examples.

### Example 1

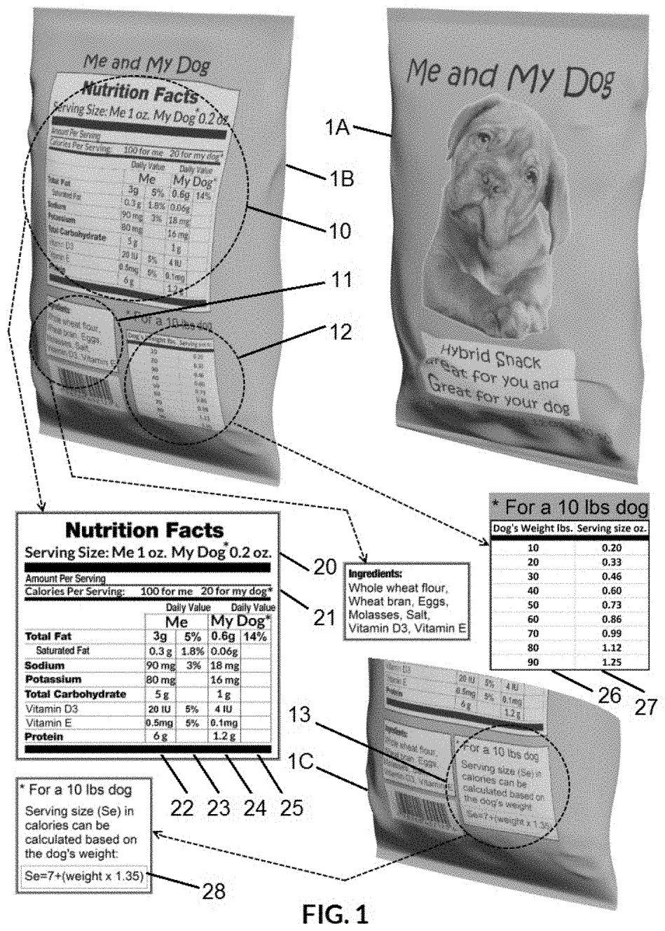

FIG. 1. shows an example for a hybrid snack for people and dogs. “Me and My Dog” is the brand name for this hybrid snack of this example, as seen on the front size of the package (1A). It is also stated on the package that this is a “Hybrid Snack, Great for you and Great for your dog” (1A). It will be sold in snacks' bags of different sizes. “Me and My Dog” will be baked in an oven, and will include a tasty mix of flour, eggs, and other ingredients, as listed in the Ingredients list (11) at the back side of the package (1B). The specific items of list (11) are for the purpose of the example only. This baked snack will be healthy and tasty for people and for dogs. The Nutrition Facts table (10) indicates both a person related data and a dog related data. The serving size weight (20) is 1 oz for a person and 0.2 oz for a dog. The Serving size in calories (21) is 100 calories for a person and 20 calories for the dog. However, the * mark (20 and 21) is referring to a note which is also printed on the back of the package (1B), which indicates that both the serving weight size and the serving calories value relate to a 10 lbs dog. In addition, a table (12) is provided, with two columns: A dog's weight in lbs (26) and the related serving size in oz (27).

Another embodiment with an alternative to table (12) is label (13), as shown on the alternative package's back side (1C). Label (13) includes the note “* For a 10 lbs dog”, and farther provides the formula (28) of SE=7+(weight×1.35), together with the following text: “Serving Size (Se) in calories can be calculated based on the dog's weight”. So, while the recommended serving size, as indicated on the package, is 20 calories for a 10 lbs dog, the serving size for a bigger dog can be calculated based on said formula.

The Nutrition Facts table (10) includes 4 columns. The first two columns (22) and (23), which are marked as “Me”, refer to a person. Column (22) indicates the components' weight per serving for a person, and column (23) indicates the components' percentage of recommended daily values per serving for a person.

The next two columns (24) and (25), which are marked as “My Dog”, refer to a 10 lbs dog. Column (24) indicates the components' weight per serving for the dog, and column (25) indicates the components' percentage of recommended daily values per serving for the dog. In this example, column (25) indicates the percentage of recommended daily value per serving only for one item: Total Fat. However, column (23) indicates the percentage of recommended daily values per serving for additional 4 items. As said, the information relating to a person and to a pet is not obliged to be fully aligned.

While the Nutrition Facts table in this example is a common table for both the person and the pet, it should be noted that two separate Nutrition Facts data labels can be prepared and printed on the package—one for people, with all information required based on people's food regulations, and a separate Nutrition Facts information label which refers to the pet and is aligned with the detailing requirements associated with pets' food.

This concludes the first example. So, every day, when Mr. X returns to his home from work, he will sit in front of the television, while his dog is sitting in front of him. Mr. X will open a package of “Me and My Dogs” snack. He will pour some of its content to a paper plate and serve it to his dog. Then, Mr. X will eat the rest of the snacks from the package. They are both eating the snacks and watching the TV together.

### Example 2

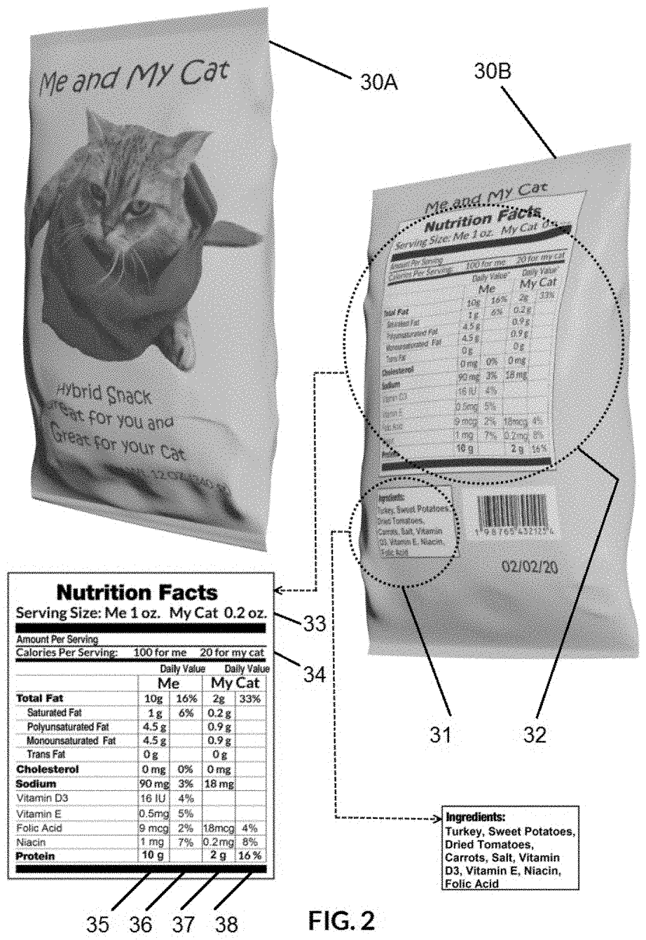

FIG. 2. shows an example for a snack for people and cats. “Me and My Cat” is the brand name for the hybrid snack of this example, as seen on the front size of the package (30A). It is also stated that this is a “Hybrid Snack, Great for you and Great for your cat” (30A). For this example, “Me and My Cat” will be a type of Jerky. It will include a reasonable amount of salt and will be very tasty for both felines and humans. Neither onions nor garlic powder would be added, whatsoever, as these ingredients are forbidden for pets. It will include turkey meat, and other ingredients including addition of vitamins and minerals, as listed in the Ingredient list (31) at the back side if the package (30B). The specific items of list (31) are for the purpose of the example. The Nutrition Facts table (32) indicates both a person related data and a cat related data. The serving size weight (33) is 1 oz for a person and 0.2 oz for a cat. The Serving size in calories (34) is 100 calories for a person and 20 calories for a cat.

The Nutrition Facts table (32) includes 4 columns. The first two columns (35) and (36), which are marked as “Me”, refer to a person. Column (35) indicates the components' weight per serving for a person, and column (36) indicates the components' percentage of recommended daily values per serving for a person.

The next two columns (37) and (38), which are marked as “My Cat”, refer to the pet. Column (37) indicates the components' weight per serving for the cat, and column (38) indicates the components' percentage of recommended daily values per serving for the cat. In this example, column (38) indicates the percentage of recommended daily value per serving for Total Fat, Folic Acid, Niacin, and Protein. Proteins are the main source of a cat's food, and therefore the percentage of recommended daily value of proteins is important for cats. It is less significant for dogs, as dogs can consume more carbohydrates, and therefore such Protein's percentage was not included for dogs in example 1. column (36) indicates the percentage of recommended daily values per serving for people, and it includes more items than the cat's column (38), as the information relating to a person and to a pet is not obliged to be fully aligned.

For example, as indicated in the Nutrition Facts table (32), the Niacin content in a person's serving is 1 mg, which is 7% of the daily recommended value for a person, and the Niacin content in a cat's serving is 0.2 mg which is 8% of the daily recommended value for a cat. All columns (35) to (38) are populated for the Niacin values in this example.

The Saturated Fat information for a person is fully provided: 1 g of Saturated Fat per serving, which is 6% of the daily recommended value for a person. The amount of Saturated Fat in a cat's serving is also indicated: 0.2 g. However, the related daily recommended value for a cat is not indicated. As shown in table (32), column 35 is populated for all items, while columns (36), (37), and (38) are partially populated and partially not.

Cats will love such hybrid snack, and it will provide them with Proteins, Vitamins and Minerals. People will love it too. It will be manufactured in a GMP production line which is approved for people, and it will be safe for both people and cats. From a nutrition perspective, all ingredients will be approved for both people and cats. Prior to marketing, tasting tests among a group of people and among a group of house cats will ensure both groups love the snack and want to share it together, above and beyond the kitchen table.

### Example 3

“WeTreat” will be a brand name for the hybrid snack of this person-dog snack example. It will be based on peanut butter, which is favorable by people, but also allowed to be consumed by dogs. No artificial sweeteners nor any nuts except for peanuts will be added, as such ingredients must not be consumed by dogs.

So, every weekend, when Mr. X will train his dog, he will use “WeTreat” as a reward. Every successful training will be followed by two treats—one for Mr. X's dog and one for Mr. X.

While some embodiments of the invention have been described by way of examples, it will be apparent that the invention can be put into practice with many modifications, variations and adaptations, and with the use of numerous variables that are within the scope of persons skilled in the art, without departing from the spirit of the invention or exceeding the scope of the claims.

1. A food product for consumption by both people and pets, comprising:
a) manufacturing practices which support both a human and a pet consumption;
b) ingredients which support consumption by both a person and a pet;
c) nutrition values which support consumption by both a person and a pet;
d) a recipe which is appealing for both a person and a pet;

2. A product according to claim 1 where said pets are canines.

3. A product according to claim 1 where said pets are felines.

4. A product according to claim 1 where said pets are both dogs and cats.

5. A product according to claim 1 where said food product is a supplementary food for the pet.

6. A product according to claim 1 where said food product is a snack.

7. A product according to claim 1 where said food product is a treat.

8. A product according to claim 1 where said food product is the main source of nutrition for the pet.
